(19) United States
(12) Patent Application Publication
(10) Pub. No.: US 2011/0314864 A1
(43) Pub. Date: Dec. 29, 2011

(54) REFRIGERATOR

(75) Inventors: Tomohiro Yamaguchi, Moriyama (JP); Junpei Ohe, Hirakata (JP)

(73) Assignee: PANASONIC ELECTRIC WORKS CO., LTD., Kadoma-shi, Osaka (JP)

(21) Appl. No.: 13/148,887

(22) PCT Filed: Mar. 12, 2010
(86) PCT No.: PCT/JP2010/054719

§ 371 Date: Aug. 10, 2011

(30) Foreign Application Priority Data
Mar. 12, 2009 (JP) 2009-060075

(51) Int. Cl. F25J 1/00; B01J 19/08

(52) U.S. Cl. 62/606; 422/186.04

(57) ABSTRACT

An effective component generator (56) that releases effective components in a storing compartment (3) includes an effective component generator, which generates the effective components when discharging occurs, and an effective component generation passage (54) in which the effective component generator is arranged. The effective component generator includes an electrode unit (58) and an insulative spacer (57) arranged in contact with or near the electrode unit. High voltage is applied to the electrode unit so that discharging occurs in a fine discharge area (S) formed along the insulative spacer. The effective component generation passage is formed so that air current sent into the effective component generator flows by the discharge area and a peripheral surface of the electrode unit.

### TECHNICAL FIELD

The present invention relates to a refrigerator including an effective component generation device.

### BACKGROUND ART

Japanese Laid-Open Patent Publication No. 2002-125642 describes a refrigerator that keeps food fresh with effective components that are generated by performing discharging. The refrigerator includes a discharging device that generates effective components, such as radicals, through corona discharging that occurs at a discharge electrode. However, when using corona discharge technique, it is difficult to stably supply a large amount of effective components.

### SUMMARY OF THE INVENTION

Accordingly, it is an object of the present invention to provide a refrigerator that allows for the use of a large amount of effective components, which are stably generated through discharging.

To achieve the above object, a first aspect of the present invention provides a refrigerator including a refrigerator body having a storing compartment. An effective component generation device is arranged in the refrigerator body and releases effective components in the storing compartment. The effective component generation device includes an effective component generator that generates the effective components when discharging occurs. An effective component generation passage accommodates the effective component generator. The effective component generator includes an electrode unit and an insulative spacer arranged in contact with or near the electrode unit. High voltage is applied to the electrode unit so that the discharging occurs in a fine discharge area formed along the insulative spacer. The effective component generation passage is formed so that air current sent into the effective component generator flows by the discharge area and a peripheral surface of the electrode unit.

In this structure, the effective component generator generates plasma with high density in the fine discharge area and thereby generates a large amount of effective components. In addition, the air current sent into the effective component generator efficiently radiates heat from the electrode unit when sending the large amount of effective components generated in the discharge area downstream. This allows a large amount of effective components to be stably generated and released over a long period of time.

Preferably, the discharge area is at least either one of a bore extending through the insulative spacer and a gap formed between the insulative spacer and the electrode unit. In this structure, the bore, the gap, or a combination of the bore and gap allows for the formation of various discharge areas with a high degree of freedom.

Preferably, the refrigerator body further includes a supplying device that supplies water to at least either one of an upstream side and downstream side of the insulative spacer in the effective component generation passage. In this structure, water is directly supplied to the discharging portion. This enhances the generation reaction of the effective components.

Preferably, the supplying device supplies the effective component generation device with condensed water produced in the storing compartment. In this structure, water is supplied to the discharging portion of the effective component generation device using condensed water without the need for a user to supplement water. This enhances the generation reaction of the effective components.

Preferably, the refrigerator body further includes a plurality of storing compartments, and the supplying device produces the condensed water using a difference in temperature between adjacent ones of the storing compartments. The plurality of storing compartments include, for example, a chilling compartment, a switching compartment, and a freezing compartment. In this structure, effective use of the temperature difference between the storing compartments efficiently produce the condensed water. Further, by using the condensed water, the effective component generation device may be continuously supplied with a sufficient amount of water for enhancing the generation reaction.

Preferably, the supplying device uses the temperature of a cooler one of the storing compartments to cool a cooling member arranged in a warmer one of the storing compartments and produce the condensed water. In this structure, the condensed water is efficiently produced on the surface of the cooling member.

As another structure for producing condensed water, preferably, the refrigerator body further includes a current passage that sends cool air into the storing compartment, and the supplying device produces the condensed water using a difference between temperature of the storing compartment and temperature of the current passage. In this structure, the temperature difference between the storing compartment and the current passage is effectively used. This efficiently produced the condensed water. Further, by using the condensed water, the effective component generation device may be continuously supplied with a sufficient amount of water for enhancing the generation reaction.

When using the temperature difference between the storing compartment and the current passage, preferably, the supplying device uses the temperature of the current passage, which is cooler than the storing compartment, to cool a cooling member arranged in the storing compartment and produce the condensed water. In this structure, the condensed water is efficiently produced on the surface of the cooling member.

As another structure of the water supplying unit, preferably, the refrigerator body further includes a water supplying unit that supplies water to an icemaker, and the water supplying unit supplies some of the water in the water supplying unit to the effective component generation device. In this structure, water is supplied to the discharging portion of the effective component generation device using the water of the icemaker without the need for a user to supplement water. This enhances the generation reaction of the effective components.

Preferably, the discharge area includes at least one bore extending through the insulative spacer, and the electrode unit includes at least one bore in alignment with or out of alignment with the bore of the insulative spacer. In this structure, when the bore of the insulative spacer is in alignment with the bore of the electrode unit, the effective component generator releases a large amount of effective components, which are generated in the discharge area, at a high flow rate. Further, the air current that flows through the bore of the electrode unit efficiently absorbs heat from the electrode unit. When the bore of the insulative spacer is out of alignment with the bore of the electrode unit, the flow rate of the air current entering the gap between the electrode unit and the insulative spacer increases. This further efficiently absorbs heat from the electrode unit and the insulative spacer.

Preferably, the effective component generation passage includes a first flow passage, which is in communication with the bore of the electrode unit and the bore of the insulative spacer, and a second flow passage, which is separate from the first flow passage and extends along the peripheral surface of the electrode unit and a peripheral surface of the insulative spacer. In this structure, the use of the separated first and second flow passages prevents the flow rate of the air current sent into the discharge area from changing greatly.

Preferably, the electrode unit is arranged in the effective component generation passage upstream to the insulative spacer, and the effective component generator includes a further electrode unit arranged downstream to the insulative spacer. The further electrode unit includes a bore having a diameter larger than that of the bore of the insulative spacer. This structure suppresses the collection of the effective components, which are generated in the discharge area, on the downstream side of the electrode unit.

Preferably, the effective component generation device further includes a liquid reservoir, which is in communication with a downstream side of the discharge area, and a device that atomizes or vaporizes liquid contained in the liquid reservoir. In this structure, the effective components are stably supplied by atomizing or vaporizing the liquid in which the effective components are dissolved.

A second aspect of the present invention provides an effective component generation device that releases effective components in a storing compartment of a refrigerator body. The effective component generation device has the same structure and advantages as the effective component generation device in the refrigerator of the first aspect described above.

Preferably, the discharge area includes a bore, which extends through the insulative spacer, and a gap, which is formed between the insulative spacer and the electrode unit. The effective component generation passage includes a first flow passage, which sends some of the air current drawn into the effective component generator to the discharge area from the peripheral surface of the electrode unit, and a second flow passage, which sends the remaining air current drawn into the effective component generator to a peripheral surface of the insulative spacer from the peripheral surface of the electrode unit. The second flow passage is in communication with the first flow passage through the discharge area. In this structure, by using the bore and the gap between the electrode unit and the insulative spacer, a large amount of effective components are stably and efficiently generated. Further, heat is effectively radiated from the electrode unit and the insulative spacer.

### BRIEF DESCRIPTION OF THE DRAWINGS

FIG. 1 is a schematic cross-sectional view showing a refrigerator according to a first embodiment of the present invention;

FIG. 2 is a schematic cross-sectional view showing an effective component generation device in the refrigerator of FIG. 1;

FIGS. 3A and 3B are schematic cross-sectional views, each showing the main part of a refrigerator according to a second embodiment of the present invention;

FIGS. 4A and 4B are schematic cross-sectional views, each showing the main part of a refrigerator according to a third embodiment of the present invention;

FIGS. 5A and 5B are schematic cross-sectional views, each showing the main part of a refrigerator according to a fourth embodiment of the present invention;

FIGS. 6A and 6B are schematic cross-sectional views, each showing the main part of a refrigerator according to a fifth embodiment of the present invention;

FIGS. 7A and 7B are schematic cross-sectional views, each showing the main part of a refrigerator according to a sixth embodiment of the present invention;

FIGS. 8A to 8D are schematic cross-sectional views showing the main part of a modification of the effective component generation device of FIG. 2;

FIG. 9 is a schematic cross-sectional view showing the main part of another modification of the effective component generation device of FIG. 2; FIGS. 10A and 10B are schematic cross-sectional views showing the main part of a further modification of the effective component generation device of FIG. 2;

FIG. 11 is a schematic cross-sectional view showing the main part of still another modification of the effective component generation device of FIG. 2; and

FIG. 12 is a schematic cross-sectional view showing the main part of yet another modification of the effective component generation device of FIG. 2.

### DETAILED DESCRIPTION OF THE EMBODIMENTS

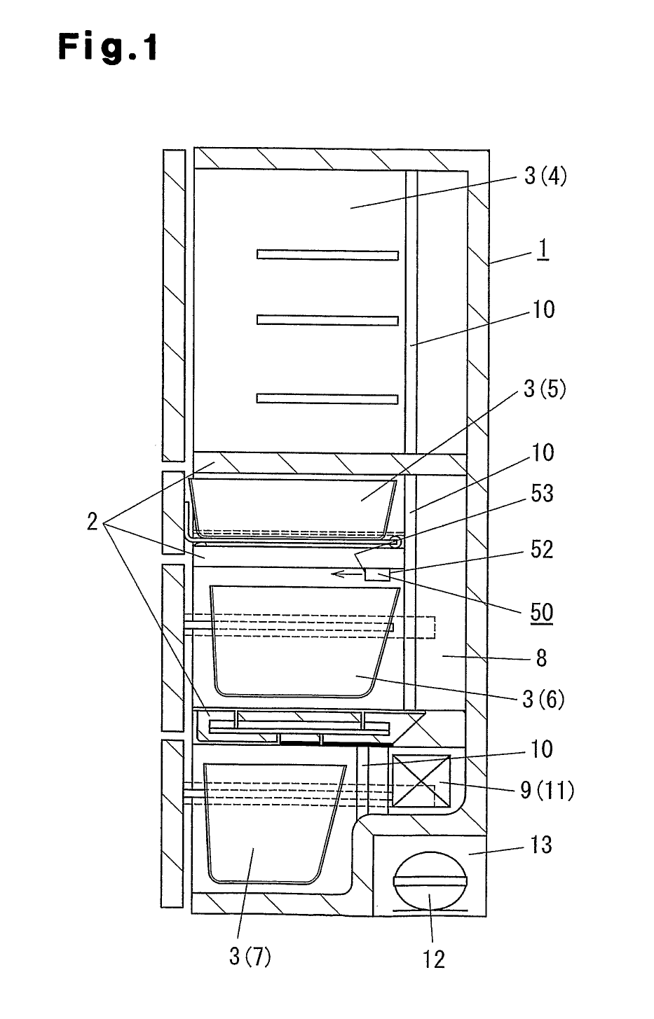

The present invention will now be discussed with reference to the accompanying drawings. FIG. 1 is a schematic cross-sectional view showing a refrigerator according to a first embodiment of the present invention.

The refrigerator of this embodiment includes a refrigerator body 1, which has an interior vertically divided by a plurality of horizontal partitions 2 into a plurality of storing compartments 3. In the illustrated example, the storing compartments 3 include a chilling compartment 4, a switching compartment 5, a vegetable compartment 6, and a freezing compartment 7.

The temperature of the chilling compartment 4 is maintained at approximately 3° C. to 5° C. The temperature of the switching compartment 5 is maintained at approximately −3° C. when used as a partial freezing compartment and approximately 0° C. when used as a chilled compartment. The temperature of the vegetable compartment 6 is maintained at about 5° C. to 7° C., and the temperature of the freezing compartment 7 is maintained at about −18° C.

A current passage 8, which delivers cooling air, is formed in the rear of the compartments 4, 5, 6, and 8. A blowing means (not shown) formed by an agitation fan delivers cooling air, which is generated by a cooler 9 through heat exchange, into each of the compartments 4, 5, 6, and 7.

The current passage 8 is partitioned from the compartments 4, 5, 6, and 7 by a vertical partition 10, which extends toward the front in the interior of the refrigerator body 1. The cooling air delivered from the cooler 9 maintains the temperature in the current passage 8 at about −20° C. to −30° C. Accordingly, the order in compartment temperature from the cooler one is the current passage 8, the freezing compartment 7, the switching compartment 5 (partial compartment and chilled compartment), the chilling compartment 4, and the vegetable compartment 6.

An evaporator 11 is used as the cooler 9. The evaporator 11 forms a refrigerating device together with a compressor 12, which is arranged below the evaporator 11, a condenser (not shown), and a decompression device (not shown), which includes an expansion valve or a capillary tube. The refrigerating device circulates refrigerant though pipes coupled to the devices (evaporator 11, compressor 12, condenser, and decompression device) and forms a refrigeration cycle. The evaporator 11 is arranged at the rear of the freezing compartment 7 and partitioned by a vertical partition 10. The compressor 12 and the evaporator are arranged in a mechanical compartment 13, which is formed in a bottom portion of the refrigerator body 1.

The refrigerator body 1 further includes an effective component generation device 50, which performs discharging to generate various types of effective components. In the illustrated example, the effective component generation device 50 is arranged in the vegetable compartment 6 on a top surface and performs discharging to generate various types of effective components that are released into the vegetable compartment 6.

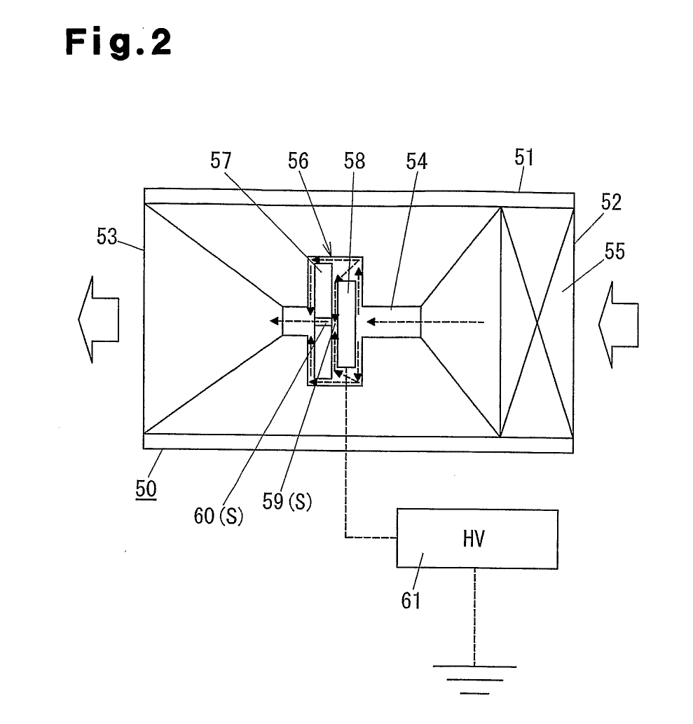

The structure of the effective component generation device 50 will now be discussed in detail with reference to FIG. 2.

As shown in FIG. 2, the effective component generation device 50 includes a case 51, which forms an outer shell of the entire device. The case 51 includes an inlet 52 and an outlet 53. The effective component generation device 50 also includes an effective component generation passage 54, which connects the inlet 52 and the outlet 53. The effective component generation passage 54 has an upstream side in which a blower unit 55 is arranged and a downstream side in which an effective component generator 56 is arranged. The blower unit 55 includes an exclusive fan, which is driven and rotated to draw air into the effective component generation passage 54 through the inlet 52 from outside of the case 51 and then force the air out from the effective component generation passage 54 through the outlet 53.

The effective component generator 56 generates microplasma, which is of a micrometer size, with high density in a small discharge area S. For example, the effective component generator 56 includes a disk-shaped insulative spacer 57 and a disk-shaped electrode unit 58. The electrode unit 58 has a diameter that is smaller than that of the spacer 57 and is arranged upstream to and near the insulative spacer 57. The shapes of the insulative spacer 57 and the electrode unit 58 are not limited to disk-like shapes. A gap 59 having a substantially uniform width of several hundreds of micrometers (μm) is formed between the spacer 57 and the electrode unit 58. A fine bore 60 having a diameter of several hundreds of micrometers (μm) extends through the center of the insulative spacer 57.

The electrode unit 58 may be formed from a known material that is preferable for use as an electrode. Further, the material of the electrode unit 58 is not limited to a metal and may be a conductive resin or the like. The insulative spacer 57 may be formed from a suitable material. However, a ceramic material such as alumina is preferable for the insulative spacer 57.

The gap 59, which has a fine width and which is formed between the insulative spacer 57 and the electrode unit 58, includes a peripheral portion and a central portion. The peripheral portion is in communication with the surrounding effective component generation passage 54. The central portion is in communication with the bore 60 extending through the insulative spacer 57. The bore 60 includes an upstream end, which is communication with the gap 59, and a downstream end, which is in communication with the downstream side of the effective component generation passage 54.

Accordingly, as indicated by the arrows in FIG. 2, the air current generated by the blower unit 55 first strikes the flat surface of the electrode unit 58 at the upstream side of the effective component generation passage 54 and detours the peripheral surface of the electrode unit 58. The air current is then branched into a flow that passes through the gap 59 and a flow that moves along the peripheral surface of the insulative spacer 57. The two flows join at the downstream side of the bore 60 and are then forced out of the case 51 from the outlet 53.

A high voltage application unit 61 has a negative side connected to the electrode unit 58 of the effective component generator 56 to apply high voltage to the electrode unit 58. This starts microplasmic discharging in the bore 60 of the insulative spacer 57 and the gap 59 formed between the insulative spacer 57 and the electrode unit 58. In this example, a fine discharge area S is defined by the gap 59 and the bore 60, which is in communication with the downstream side of the gap 59, and microplasmic discharging occurs in the discharge area S.

In the effective component generation device 50 of this example, to generate effective components and force the effective components out of the case 51, the blower unit 55 draws ambient air into the effective component generation passage 54 and the high voltage application unit 61 applies high voltage to the electrode unit 58 of the effective component generator 56. As a result, microplasmic discharging occurs in the discharge area S. The microplasmic discharging generates effective components with a much higher density than corona discharging in the discharge area S (i.e., the gap 59 and the bore 60).

The air current directed toward the effective component generator 56 by the blower unit 55 flows along the flat surface of the electrode unit 58, which faces toward the upstream side of the effective component generation passage 54, and the peripheral surface of the electrode unit 58 toward a location where the air current strikes a peripheral edge of the insulative spacer 57. Part of the air current striking the peripheral edge of the insulative spacer 57 is sent into the gap 59 and the remainder of the air current is sent to the flow passage that detours the insulative spacer 57.

The air current sent into the gap 59 flows downstream carrying the large amount of effective components generated in the discharge area S, which is formed by the gap 59 and the bore 60, while absorbing heat from the electrode unit 58 and the insulative spacer 57. The air current detouring the insulative spacer 57 absorbs heat from the insulative spacer 57 and joins the air current forced out of the bore 60. The joined air currents are then forced out of the outlet 53 at a sufficient flow rate. The outgoing current having the sufficient flow rate carries a large amount of effective components, which are generated by the microplasmic discharging of the effective component generator 56, and is strongly forced out of the effective component generation device 50.

In this manner, the effective component generation device 50 of this example generates a large amount of effective components by performing microplasmic discharging in the discharge area S, while effectively radiating heat from the electrode unit 58 of the effective component generator 56 and the insulative spacer 57 with air currents. In addition, as an air current flows downstream from the bore 60, the air current efficiently carries the large amount of effective components generated in the discharge area S from the bore 60. Further, the air current forced out of the bore 60 joins the branched air current that has absorbed heat from the peripheral space of the insulative spacer 57. This forces an air current out of the effective component generation device 50 at a sufficient flow rate.

The generated and released effective components may be, for example, hydroxy radicals, superoxide radicals, nitrate ions, or nitrogen oxides. The generation balance of the above effective components is adjustable by adjusting the discharging conditions. When a sufficient amount of hydroxy radicals or superoxide radicals are released out of the effective component generation device 50, a deodorizing effect, a sterilization effect, an allergen inactivation effect, an agrochemical decomposition effect, an organic substance decomposition (cleansing) effect, and the like are obtained.

For the discharging that generates the effective components, it is preferred that discharging be performed at several hundred microamperes (μA) to several tens of milliamperes (mA). The discharging raises the temperature of the electrode unit 58 to a range of several tens to several hundred degrees Celsius (° C.). However, in the present invention, the effective component generator 56 is arranged in the effective component generation passage 54. Thus, air current from the blower unit 55 passes through the discharge area S of the effective component generator 56 or detours and passes the peripheral surface of the electrode unit 58 as it absorbs heat from the electrode unit 58. This suppresses the rising of the temperature.

Further, in the refrigerator including the refrigerator body 1 with the effective component generation device 50 shown in FIG. 2, the various types of effective components released from the outlet 53 of the effective component generation device 50 is diffused in the vegetable compartment 6. By releasing a sufficient amount of hydroxyl radicals, superoxide radicals, or the like as the effective components, a freshness sustaining effect, such as a sterilization effect, is produced for foods (not shown) such as vegetables that are stored in the vegetable compartment 6.

In the example shown in FIG. 1, the effective component generation device 50 is arranged on the top surface of the vegetable compartment 6 (i.e., the lower surface of the horizontal partition 2 partitioning the vegetable compartment 6 and the switching compartment 5). However, the effective component generation device 50 may be arranged at other locations, such as on a side surface, rear surface, or bottom surface of the vegetable compartment 6. Further, in the example shown in FIGS. 1 and 2, the outlet 53 opens in the horizontal direction, and effective components are released in the horizontal direction from the top side. However, the effective components may be released in other directions, such as a downward direction.

The storing compartment in which the effective component generation device 50 is arranged is not limited to the vegetable compartment 6. In other words, even when the effective component generation device 50 is arranged in another storing compartment 3, such as the chilling compartment 4, the switching compartment 5, and the freezing compartment 7, the freshness of the stored foods may be sustained by releasing effective components into the corresponding storing compartment 3.

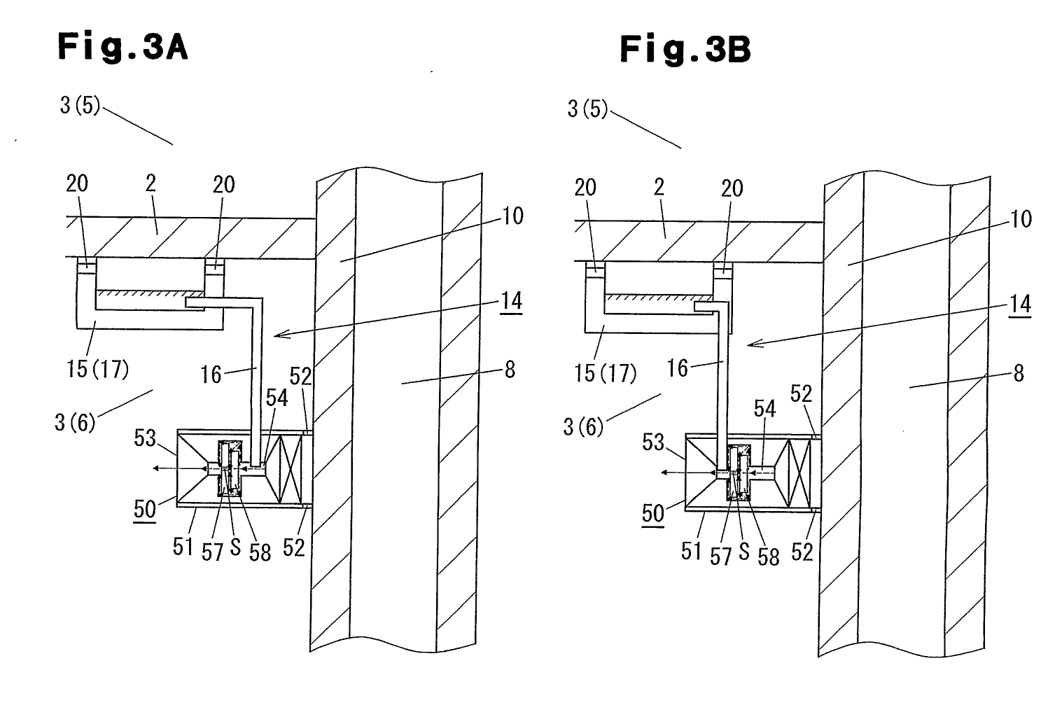

FIGS. 3A and 3B are schematic views showing the main part of a refrigerator according to a second embodiment of the present invention. To avoid redundancy, like or same reference numerals are given to those components that are the same as the corresponding components of the first embodiment. Such components will not be described in detail. Only the features that differ from the first embodiment will be described below.

In the refrigerator of the second embodiment, the effective component generation device 50 is arranged on the rear surface of the vegetable compartment 6. The inlet 52 of the effective component generation device 50 is arranged in a side wall of the case 51.

Further, in the refrigerator of the second embodiment, a supplying device 14, which supplies water into the effective component generation passage 54, is arranged on the refrigerator body 1. The supplying device 14 includes a water tank 15, which produces and contains condensed water, and a water conveying body 16, which conveys water from the water tank 15 to the effective component generation device 50. For example, as shown in FIG. 3A, the water conveying body 16 conveys water from the water tank 15 to a location in the effective component generation passage 54 that is upstream to the insulative spacer 57. Alternatively, as shown in FIG. 3B, the water conveying body 16 conveys water to a location in the effective component generation passage 54 that is downstream to the insulative spacer 57.

The water tank 15 is arranged continuously with and downward from the top surface of the vegetable compartment 6 (i.e., the lower surface of the horizontal partition 2 partitioning the vegetable compartment 6 and the switching compartment 5). Further, the water tank 15 is formed from a material having high thermal conductivity. A plurality of ventilation holes 20 are formed in the water tank 15 to draw in air from the vegetable compartment 6.

The switching compartment 5, the temperature of which is lower than the vegetable compartment 6, is arranged above the vegetable compartment 6 with the horizontal partition 2 located in between. Accordingly, the horizontal partition 2 cools a surface of the water tank 15. Thus, the temperature of this surface is kept low and thereby produces condensed water. In other words, in the second embodiment, the water tank 15 also serves as a cooling member 17, which generates condensed water. The condensed water produced on the inner surface of the water tank 15 is stored in the water tank 15 and conveyed to the effective component generation device 50 by the water conveying body 16.

The water conveying body 16, which uses the capillary phenomenon to convey water from one of its ends to the other one of its ends, is formed from felt or the like. However, the water conveying body 16 may have a pipe-shaped structure instead. Further, a pump may be used to convey water from the water tank 15 to the effective component generation device 50.

In the structure shown in FIG. 3A, one end of the water conveying body 16 is located in the water tank 15, and the other end of the water conveying body 16 is located upstream to the insulative spacer 57 in the effective component generation passage 54 near the discharge area S. As a result, water is supplied to the other end of the water conveying body 16, which is located at the upstream side of the effective component generator 56, so that water is directly supplied to the upstream vicinity of the discharge area S.

The water supplied to the upstream vicinity of the discharge area S is sent to the discharging portion in the discharge area S by the pressure of an air current and acts to drastically enhance the generation reaction of the effective components. In detail, the enhanced generation reaction may be the reaction of water molecules (H₂O) with oxygen molecules (O₂) that generates hydroxy radicals (·OH). Further, nitrogen molecules (N₂) or various types of components derived from nitrogen molecules may react with water molecules (H₂O) and generate hydroxy radicals (·OH). Moreover, the reaction enhancement further enhances the reaction that generates hydrogen peroxide (H₂O₂).

In the structure shown in FIG. 3B, one end of the water conveying body 16 is located in the water tank 15, and the other end of the water conveying body 16 is located downstream to the insulative spacer 57 in the effective component generation passage 54 near the discharge area S. As a result, water is sequentially supplied to the other end of the water conveying body 16, which is located at the downstream side of the effective component generator 56, so that water is directly supplied to the downstream vicinity of the discharge area S.

The actual discharging portion in the effective component generation passage 54 is enlarged to the downstream side of the discharge area S by the pressure of an air current. Thus, the generation reaction of the effective components is drastically enhanced by supplying water to the downstream vicinity of the discharge area S. The generation reaction that is enhanced here is the same as the reaction described for FIG. 3A.

The water conveying body 16 may convey water to both of the upstream and downstream sides of the insulative spacer 57. In such a case, the water conveying body 16 may have one end located in the water tank 15 and the other end branched into two, namely, a first end and a second end. In this structure, the branched first end may be located at the downstream side of the insulative spacer 57, and the branched second end may be located at the upstream side of the insulative spacer 57. A structure including each of the water conveying body 16 shown in FIG. 3A and the water conveying body 16 shown in FIG. 3B is also preferable.

In the refrigerator of the second embodiment, the generation reaction of effective components may be enhanced without requiring a user to supply water by using the condensed water produced in the vegetable compartment. The water tank 15 may also be arranged continuously with the bottom surface of the vegetable compartment 6 (i.e., the upper surface of the horizontal partition 2 partitioning the vegetable compartment 6 and the freezing compartment 7, which is located below the vegetable compartment 6) and produce condensed water using the temperature difference between the vegetable compartment 6 and the freezing compartment 7.

The same structure may be employed in the other storing compartments 3. When producing condensed water in the chilling compartment 4 using the temperature difference with the adjacent switching compartment 5, which is located below the chilling compartment 4, it is preferable that the water tank 15 be arranged continuously with the bottom surface of the chilling compartment 4 (i.e., the upper surface of the horizontal partition 2 partitioning the chilling compartment 4 and the switching compartment 5, which is located below the chilling compartment 4).

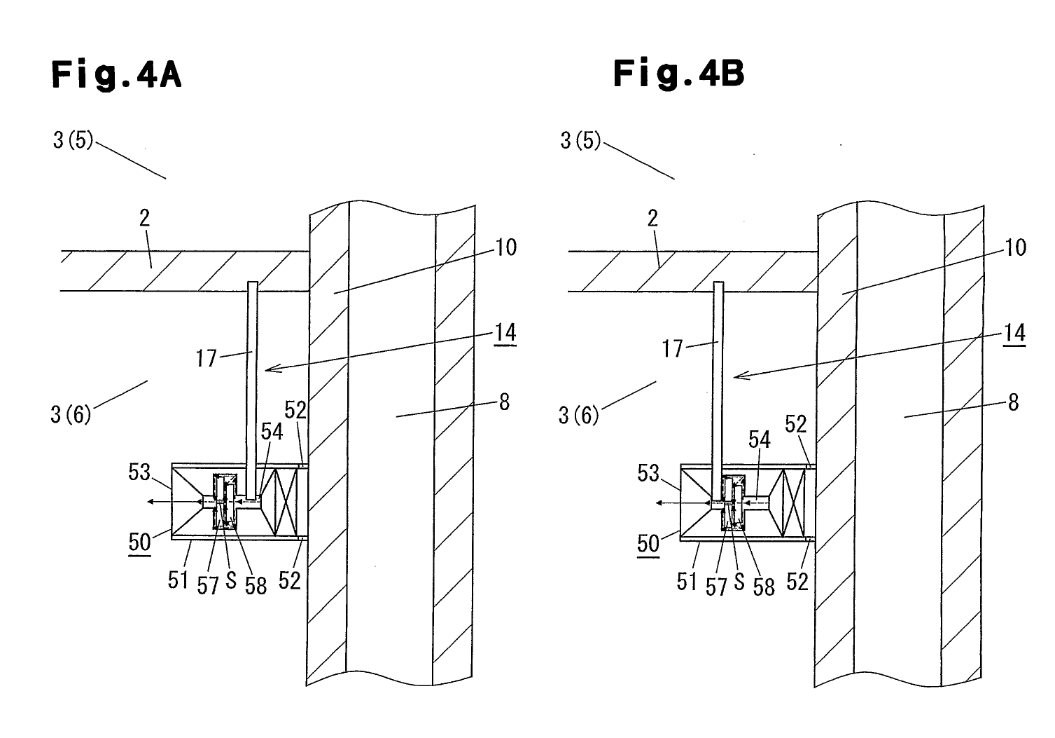

FIGS. 4A and 4B are schematic views showing the main part of a refrigerator according to a third embodiment of the present invention. To avoid redundancy, like or same reference numerals are given to those components that are the same as the corresponding components of the second embodiment. Such components will not be described in detail. Only the features that differ from the second embodiment will be described below.

The supplying device 14 included in the refrigerator of the third embodiment is the same as the second embodiment in that the temperature difference between adjacent storing compartments 3 is used to produce condensed water. However, the third embodiment does not include each of the water tank 15 (cooling member 17), which produces condensed water in the same manner as the second embodiment, and the water conveying body 16, which conveys water from the water tank 15 to an intended location. Instead, the cooling member 17 directly produces condensed water at the intended location. In other words, the supplying device 14 of the third embodiment does not include the water tank 15 and the water conveying body 16 of the second embodiment.

The cooling member 17 of the third embodiment is rod-shaped and formed from a material having high thermal conductivity such as aluminum. For example, as shown in FIG. 4A, the cooling member 17 is arranged in the effective component generation passage 54 at the upstream side of the insulative spacer 57 to directly produce condensed water at this location. Alternatively, as shown in FIG. 4B, the cooling member 17 is arranged in the effective component generation passage 54 at the downstream side of the insulative spacer 57 to directly produce condensed water at this location.

In the structure shown in FIG. 4A, the cooling member 17 has one end coupled to the top surface of the vegetable compartment 6 (i.e., the lower surface of the horizontal partition 2 partitioning the vegetable compartment 6 and the switching compartment 5, which is located above the vegetable compartment 6). Further, the cooling member 17 has another end exposed in the effective component generation passage 54 at the upstream side of the insulative spacer 57 near the discharge area S. The horizontal partition 2 cools the cooling member 17 and keeps the temperature at the exposed surface low so as to directly produce condensed water on the exposed surface. This allows for water to be directly supplied to the upstream vicinity of the discharge area S.

In the structure shown in FIG. 4B, the cooling member 17 has one end coupled to the top surface of the vegetable compartment and another end exposed in the effective component generation passage 54 at the downstream side of the insulative spacer 57 near the discharge area S. The horizontal partition 2 cools the cooling member 17 and keeps the temperature at the exposed surface low so as to directly produce condensed water on the exposed surface. This allows for water to be directly supplied to the downstream vicinity of the discharge area S.

The cooling member 17 may produce condensed water at both of the upstream and downstream sides of the insulative spacer 57. In such a case, the cooling member 17 may have one end coupled to the top surface of the vegetable compartment 6 and the other end branched into two, namely, a first end and a second end. In this structure, the branched first end may be located at the downstream side of the insulative spacer 57, and the branched second end may be located at the upstream side of the insulative spacer 57. A structure including each of the cooling member 17 shown in FIG. 4A and the cooling member 17 shown in FIG. 4B is also preferable.

The cooling member 17 may also be coupled to the bottom surface of the vegetable compartment 6 (i.e., the upper surface of the horizontal partition 2 partitioning the vegetable compartment 6 and the freezing compartment 7, which is located below the vegetable compartment 6) and produce condensed water at the exposed surface of the other end of the cooling member 17 using the temperature difference between the vegetable compartment 6 and the freezing compartment 7.

The same structure may be employed in the other storing compartments 3. When directly producing condensed water in the chilling compartment 4 using the temperature difference with the adjacent switching compartment 5, which is located below the chilling compartment 4, it is preferable that the cooling member 17 have one end coupled to the bottom surface of the chilling compartment 4 (i.e., the upper surface of the horizontal partition 2 partitioning the chilling compartment 4 and the switching compartment 5, which is located below the chilling compartment 4).

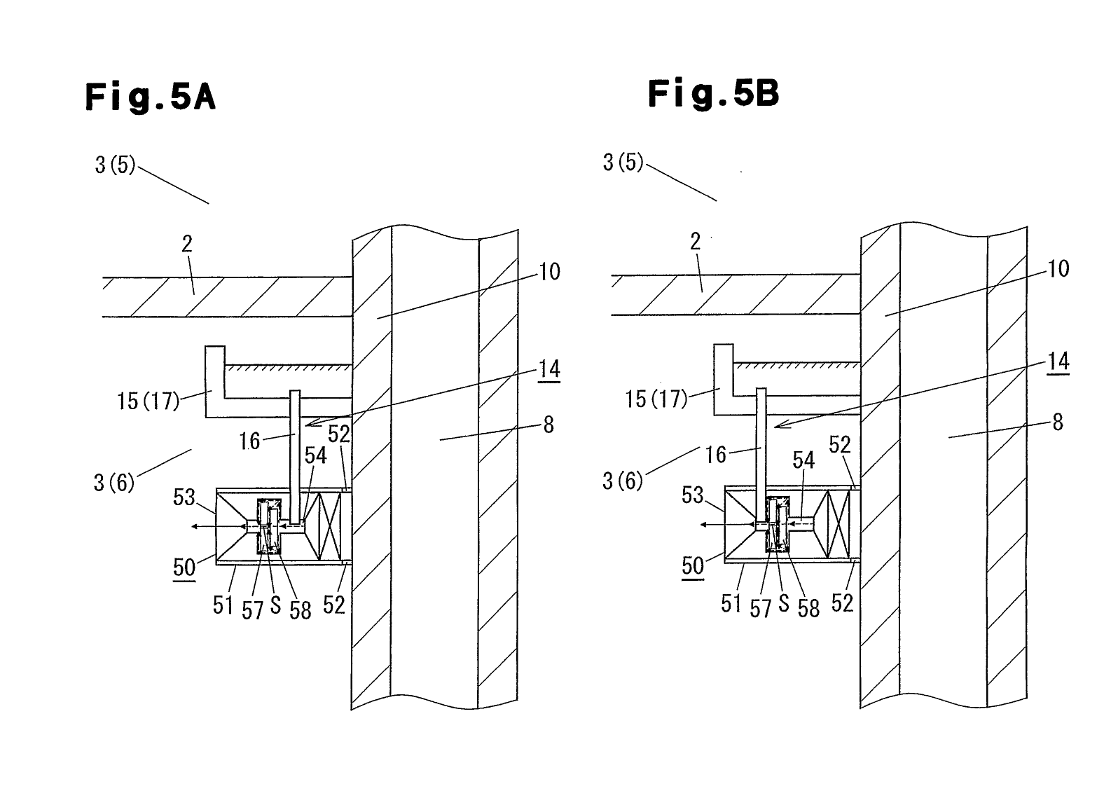

FIGS. 5A and 5B are schematic views showing the main part of a refrigerator according to a fourth embodiment of the present invention. To avoid redundancy, like or same reference numerals are given to those components that are the same as the corresponding components of the second embodiment. Such components will not be described in detail. Only the features that differ from the second embodiment will be described below.

The supplying device 14 included in the refrigerator of the fourth embodiment does not use the temperature difference between adjacent storing compartments 3 to produce condensed water like in the second embodiment. Instead, the temperature difference between a storing compartment 3 and the current passage 8 is used to produce condensed water.

In the supplying device 14 of the fourth embodiment, a water tank 15 (cooling member 17), similar to that of the second embodiment, is arranged continuously with the rear surface of the vegetable compartment 6 (i.e., front surface of the vertical partition 10 partitioning the vegetable compartment 6 and the current passage 8, which is located behind the vegetable compartment 6). The water tank 15 (cooling member 17) is formed from a material having high thermal conductivity and has an upper opening.

The current passage 8, the temperature of which is lower than the vegetable compartment 6, is arranged behind the vegetable compartment 6 with the vertical partition 10 located in between. Accordingly, the vertical partition 10 cools a surface of the water tank 15 and keeps the temperature of this surface low. This produces condensed water on the surface. The condensed water produced on the inner surface of the water tank 15 is stored in the water tank 15 and conveyed to the effective component generation device 50 by the water conveying body 16.

For example, as shown in FIG. 5A, the water conveying body 16 may be arranged to convey water from the water tank 15 to the upstream side of the insulative spacer 57 in the effective component generation passage 54. Alternatively, as shown in FIG. 5B, the water conveying body 16 may be arranged to convey water from the water tank 15 to the downstream side of the insulative spacer 57 in the effective component generation passage 54.

In the same manner as the second embodiment, the water conveying body 16 may convey water to both of the upstream and downstream sides of the insulative spacer 57. In such a case, the water conveying body 16 may have one end located in the water tank 15 and the other end branched into two, namely, a first end and a second end. In this structure, the branched first end may be located at the downstream side of the insulative spacer 57, and the branched second end may be located at the upstream side of the insulative spacer 57. A structure including each of the water conveying body 16 shown in FIG. 5A and the water conveying body 16 shown in FIG. 5B is also preferable.

The same structure as the fourth embodiment may be employed in the other storing compartments 3, namely, the chilling compartment 4, the switching compartment 5, and the freezing compartment 7. When producing condensed water in any one of the storing compartments 3, it is preferable that the water tank 15 be arranged continuously with the vertical partition 10, which partitions the corresponding storing compartment 3 and the current passage 8, to produce condensed water from the moisture in the storing compartment 3 using the temperature difference with the current passage 8.

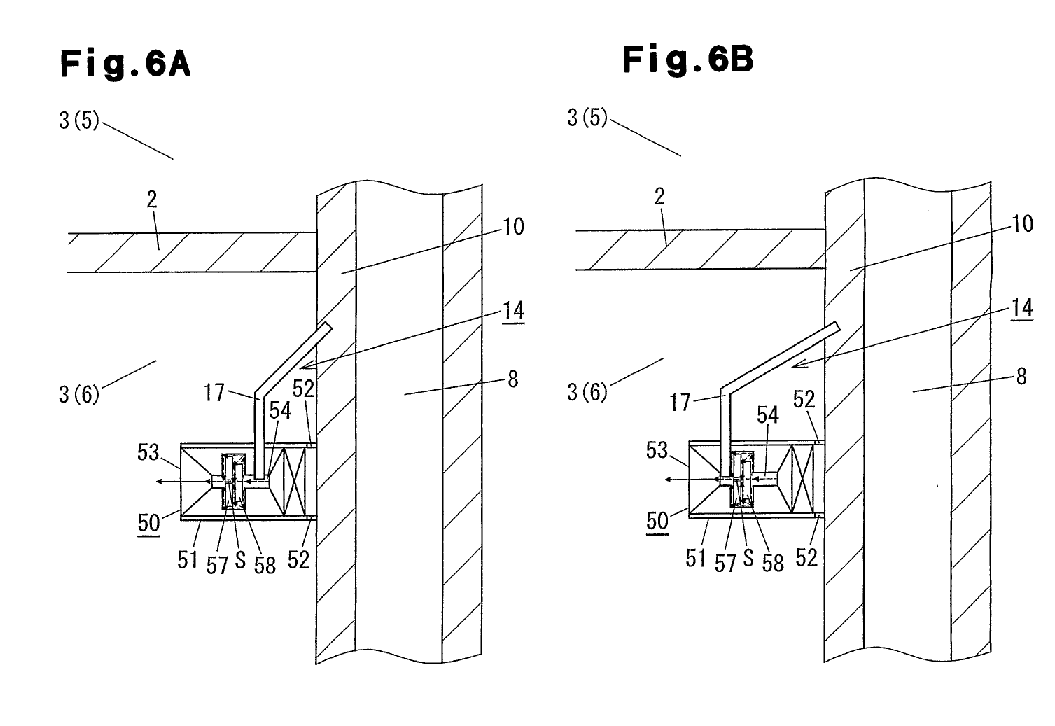

FIGS. 6A and 6B are schematic views showing the main part of a refrigerator according to a fifth embodiment of the present invention. To avoid redundancy, like or same reference numerals are given to those components that are the same as the corresponding components of the fourth embodiment. Such components will not be described in detail. Only the features that differ from the fourth embodiment will be described below.

The supplying device 14 included in the refrigerator of the fifth embodiment is similar to the fourth embodiment in that it also uses the temperature difference between one of the storing compartments 3 and the adjacent current passage 8 to produce condensed water. However, the fifth embodiment does not include each of the water tank 15 (cooling member 17), which produces condensed water, and the water conveying body 16, which transfers water to the intended location, like in the fourth embodiment. Instead, the fifth embodiment directly produces condensed water at the intended location with the cooling member 17. In other words, the supplying device 14 of the fifth embodiment does not include the water tank 15 and the water conveying body 16 like in the fourth embodiment.

The cooling member 17 of the fifth embodiment is rod-shaped and formed from a material having high thermal conductivity such as aluminum. For example, as shown in FIG. 6A, the cooling member 17 is arranged in the effective component generation passage 54 at the upstream side of the insulative spacer 57 to directly produce condensed water at this location. Alternatively, as shown in FIG. 6B, the cooling member 17 is arranged in the effective component generation passage 54 at the downstream side of the insulative spacer 57 to directly produce condensed water at this location.

In the structure shown in FIG. 6A, the cooling member 17 has one end coupled to the rear surface of the vegetable compartment (i.e., the front surface of the vertical partition 10 partitioning the vegetable compartment 6 and the current passage 8, which is located behind the vegetable compartment 6). Further, the cooling member 17 has another end exposed in the effective component generation passage 54 at the upstream side of the insulative spacer 57 near the discharge area S. The vertical partition 10 cools the cooling member 17 and keeps the temperature at the exposed surface low so as to directly produce condensed water on the exposed surface. This allows for water to be directly supplied to the upstream vicinity of the discharge area S.

In the structure shown in FIG. 6B, the cooling member 17 has one end coupled to the rear surface of the vegetable compartment and another end exposed in the effective component generation passage 54 at the downstream side of the insulative spacer 57 near the discharge area S. The vertical partition 10 cools the cooling member 17 and keeps the temperature at the exposed surface low so as to directly produce condensed water on the exposed surface. This allows for water to be directly supplied to the downstream vicinity of the discharge area S.

The cooling member 17 may produce condensed water at both of the upstream and downstream sides of the insulative spacer 57. In such a case, the cooling member 17 may have one end coupled to the rear surface of the vegetable compartment 6 and the other end branched into two, namely, a first end and a second end. In this structure, the branched first end may be located at the downstream side of the insulative spacer 57, and the branched second end may be located at the upstream side of the insulative spacer 57. A structure including each of the cooling member 17 shown in FIG. 6A and the cooling member 17 shown in FIG. 6B is also preferable.

The same structure as the fifth embodiment may be employed in the other storing compartments 3, namely, the chilling compartment 4, the switching compartment 5, and the freezing compartment 7. When producing condensed water in any one of the storing compartments 3, it is preferable that the cooling member 17 be arranged continuously with the vertical partition 10, which partitions the corresponding storing compartment 3 and the current passage 8, to produce condensed water from the moisture in the storing compartment 3 using the temperature difference with the current passage 8.

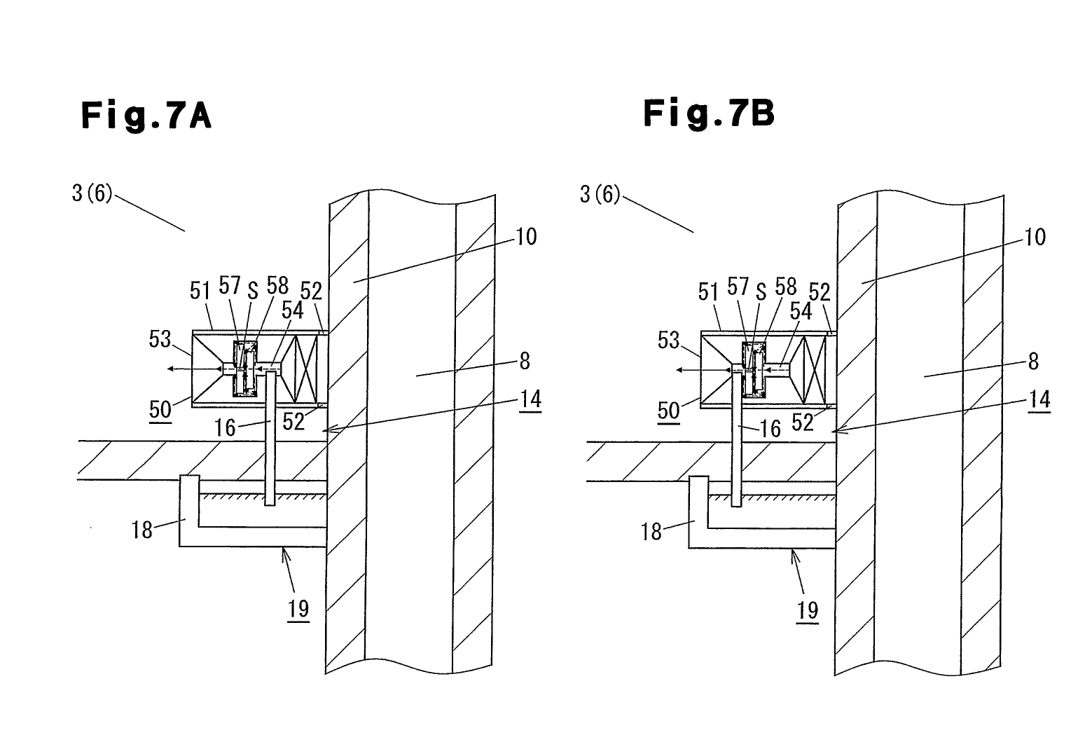

FIGS. 7A and 7B are schematic views showing the main part of a refrigerator according to a sixth embodiment of the present invention. To avoid redundancy, like or same reference numerals are given to those components that are the same as the corresponding components of the first embodiment. Such components will not be described in detail. Only the features that differ from the first embodiment will be described below.

In the refrigerator of the sixth embodiment, the effective component generation device 50 is arranged on the rear surface of the vegetable compartment 6. The inlet 52 of the effective component generation device 50 is arranged in a side wall of the case 51.

Further, in the refrigerator of the sixth embodiment, the supplying device 14, which supplies water into the effective component generation passage 54, is arranged on the refrigerator body 1. The supplying device 14 includes a water conveying body 16 that conveys some of the water in a water tank 18, which is provided in the refrigerator body 1, to the effective component generation device 50.

In the sixth embodiment, the water conveying body 16, which uses the capillary phenomenon to convey water from one of its ends to the other one of its ends, is formed from felt or the like. However, the water conveying body 16 may have a pipe-shaped structure instead. Further, a pump may be used to convey water from the water tank 18 to the effective component generation device 50.

The water tank 18 contains water that is supplied to an icemaker (not shown), which is provided in the refrigerator body 1. The water tank 18 is also connected to another water supplying route (not shown) to form a water supplying unit 19, which supplies the icemaker with water. The water conveying body 16 may be connected to a water supplying route that does not include the water tank 18 to supply water from the water supplying unit 19 to the effective component generation device 50.

For example, as shown in FIG. 7A, the water conveying body 16 conveys water to a location in the effective component generation passage 54 that is upstream to the insulative spacer 57. Alternatively, as shown in FIG. 7B, the water conveying body 16 conveys water to a location in the effective component generation passage 54 that is downstream to the insulative spacer 57.

In the structure shown in FIG. 7A, one end of the water conveying body 16 is located in the water tank 18, and the other end of the water conveying body 16 is located upstream to the insulative spacer 57 in the effective component generation passage 54 near the discharge area S. As a result, water is supplied to the other end of the water conveying body 16, which is located at the upstream side of the effective component generator 56, so that water is directly supplied to the upstream vicinity of the discharge area S.

The water supplied to the upstream vicinity of the discharge area S is sent to the discharging portion in the discharge area S by the pressure of an air current and acts to drastically enhance the generation reaction of the effective components. The enhanced generation reaction is the same as the generation reaction of the second embodiment.

In the structure shown in FIG. 7B, one end of the water conveying body 16 is located in the water tank 18, and the other end of the water conveying body 16 is located downstream to the insulative spacer 57 in the effective component generation passage 54 near the discharge area S. As a result, water is sequentially supplied to the other end of the water conveying body 16, which is located at the downstream side of the effective component generator 56, so that water is directly supplied to the downstream vicinity of the discharge area S.

The actual discharging portion in the effective component generation passage 54 is enlarged to the downstream side of the discharge area S by the pressure of an air current. Thus, the generation reaction of the effective components is drastically enhanced by supplying water to the downstream vicinity of the discharge area S. The generation reaction that is enhanced here is the same as the reaction described for the second embodiment.

The water conveying body 16 may convey water to both of the upstream and downstream sides of the insulative spacer 57. In such a case, the water conveying body 16 may have one end located in the water tank 15 and the other end branched into two, namely, a first end and a second end. In this structure, the branched first end may be located at the downstream side of the insulative spacer 57, and the branched second end may be located at the upstream side of the insulative spacer 57. A structure including each of the water conveying body 16 shown in FIG. 7A and the water conveying body 16 shown in FIG. 7B is also preferable.

In the refrigerator of the sixth embodiment, the generation reaction of effective components may be enhanced without requiring a user to supply water by using the water for the icemaker. The water tank 15 may also be arranged continuously with the bottom surface of the vegetable compartment 6 (i.e., the upper surface of the horizontal partition 2 partitioning the vegetable compartment 6 and the freezing compartment 7, which is located below the vegetable compartment 6) and produce condensed water using the temperature difference between the vegetable compartment 6 and the freezing compartment 7.

In the effective component generation device 50 of the refrigerators according to the first to sixth embodiments, the effective component generator 56 is formed by the insulative spacer 57, which is spaced from the downstream side of the electrode unit 58 by the gap 59 that has a fine width, and the bore 60, which has a fine diameter and extends through the center of the insulative spacer 57 (refer to FIG. 2). However, the structure of the effective component generation device 50 is not limited in such a manner, and various modifications may be made.

It is only required that the effective component generator 56 of the effective component generation device 50 according to the present invention include the electrode unit 58 and the insulative spacer 57, which is arranged in contact with or near the electrode unit 58, and high voltage be applied to the electrode unit 58 to cause discharging in the fine discharge area S formed along the insulative spacer 57. In this case, the discharge area S may be the bore 60, which has a fine diameter and is arranged in the insulative spacer 57, or the gap 59, which has a fine width and is arranged between the insulative spacer 57 and the electrode unit 58. The discharge area S may also be formed by both the bore 60 and the gap 59.

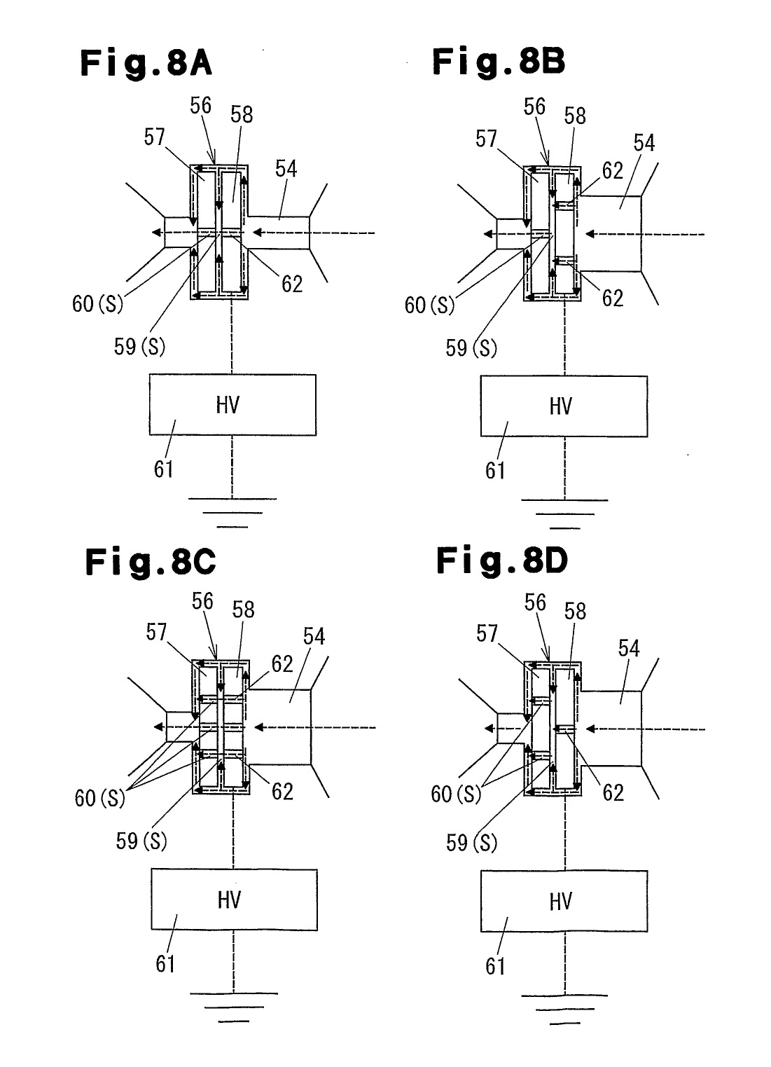

Various modifications of the effective component generation device 50 will now be described with reference to FIGS. 8 to 12. To avoid redundancy, like or same reference numerals are given to those components that are the same as the corresponding components of the effective component generation device 50 shown in FIG. 2 or those described in other modifications. Such components will not be described in detail.

FIG. 8A shows a modification in which a bore 62 extends through the center of the electrode unit 58 in addition to the insulative spacer 57. The bore 62 of the electrode unit 58 and the bore 60 of the insulative spacer 57 are aligned with the gap 59 arranged between the electrode unit 58 and the insulative spacer 57. The electrode unit 58 and the insulative spacer 57 are disk-shaped and have about the same diameter.

In the modification of FIG. 8A, air current is directly sent into the bore 60, which forms the discharge area S, from the bore 62 of the electrode unit 58. This is advantageous in that a large amount of effective components generated in the discharge area S may be released out of the effective component generation device 50 at a high flow rate. Further, there is an advantage in that the air current flowing through the bore 62 effectively absorbs heat from the electrode unit 58.

The gap between the insulative spacer 57 and the electrode unit 58 may be eliminated so that the insulative spacer 57 and the electrode unit 58 are arranged in contact with each other. In this case, the insulative spacer 57, which is in contact with the electrode unit 58, also functions as a heat radiation fin.

FIG. 8B shows a modification that differs from the modification shown in FIG. 8A in that a plurality of bores 62 are formed around the center of the electrode unit 58. The bores 62 of the electrode unit 58 are separated from the bore 60 in the axial direction of the effective component generation passage 54 to be out of alignment with the bore 60 of the insulative spacer 57. In the modification of FIG. 8B, air current from the upstream side flows through the bores 62 of the electrode unit 58, enters the gap 59, and then flows through the bore 60 of the insulative spacer 57. This is advantageous in that the air current efficiently absorbs heat from the electrode unit 58 and the insulative spacer 57. To further efficiently absorb heat from the electrode unit 58, the electrode unit 58 may be meshed so as to include a plurality of bores 62.

FIG. 8C shows a modification that differs from the modification shown in FIG. 8A in that the insulative spacer has a plurality of bores 60 and the electrode unit 58 also has a plurality of bores 62. Each bore 60 of the insulative spacer 57 is aligned with one of the bores 62 of the electrode unit 58 with the gap 59 arranged in between. The modification of FIG. 8C uses the plurality of bores 60 as the discharge area S and increases the entire effective component generation amount. In addition, an air current is sent into each bore 60 from the corresponding bore 62 of the electrode unit. This is advantageous in that a large amount of effective components may be released out of the effective component generation device 50 at a high flow rate.

In the modification of FIG. 8C, when the insulative spacer 57 and the electrode unit 58 are arranged in contact with each other, the insulative spacer 57 would also function as a heat radiation fin.

FIG. 8D shows a modification that differs from the modification shown in FIG. 8A in that a plurality of bores 60 are formed in the insulative spacer 57 and in that the bores 60 are separated from the bore 62 of the electrode unit 58 in the axial direction of the effective component generation passage 54. The modification of FIG. 8D uses the plurality of bores 60 as the discharge area S and increases the entire effective component generation amount. Further, air current flows through the bore 62 of the electrode unit 58, enters the gap 59, and then flows through the bores 60 of the insulative spacer 57. Thus, the air current efficiently absorbs heat from the electrode unit 58 and the insulative spacer 57.

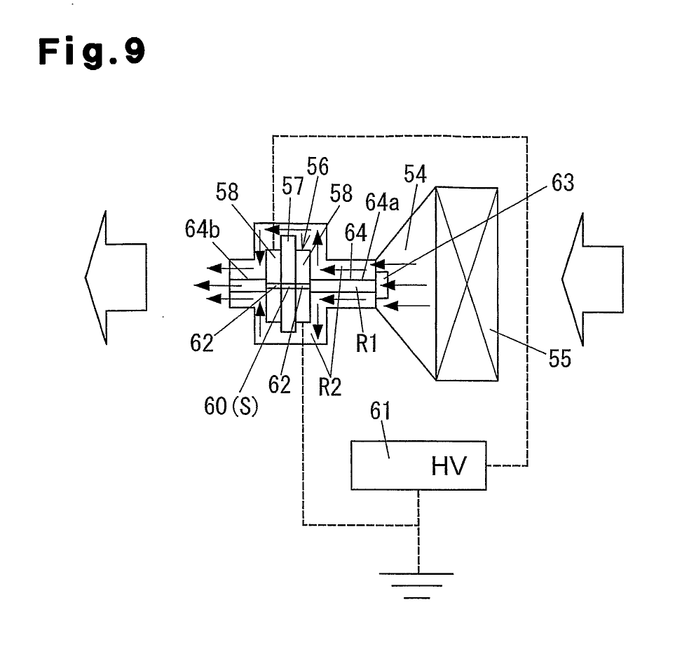

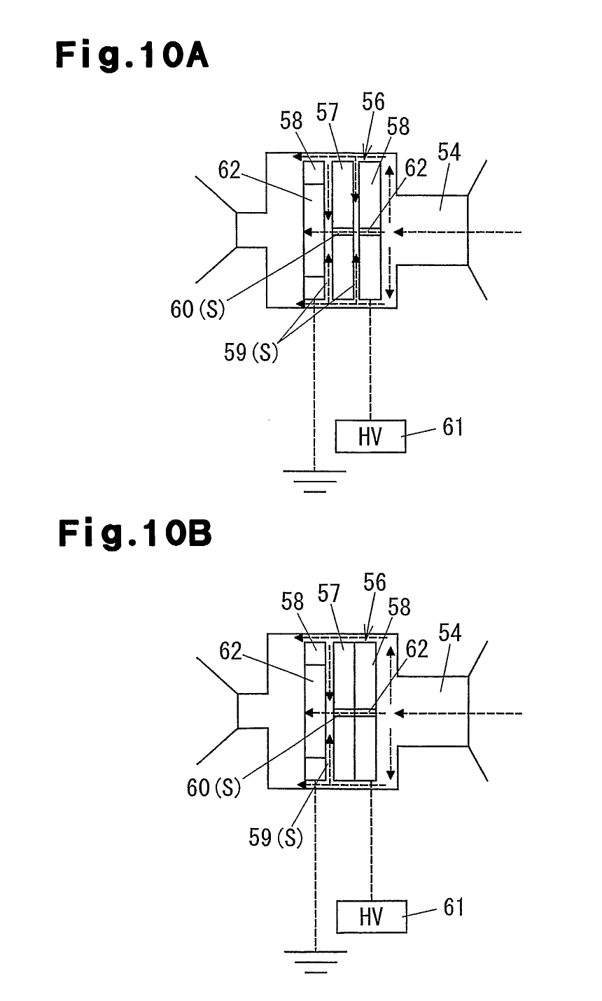

FIG. 9 shows a modification in which metal plate-shaped electrode units 58 are arranged in contact with opposite sides of the plate-shaped insulative spacer 57 in the thicknesswise direction. In other words, the insulative spacer 57 is held between a pair of electrode units 58. The pair of electrode units 58 are electrically connected to a high voltage application unit 61 so that high voltage is applied between the two electrode units 58. The bore 60 extending through the insulative spacer 57 and the bore 62 extending through each electrode unit 58 have the same shape in the thicknesswise direction. Due to the contacting arrangement of the insulative spacer 57 and the electrode unit 58, the bore 60 of the insulative spacer 57 is in communication and alignment with the bores 62 of the two electrode units 58 in the thicknesswise direction. The bores 60 and 62 have diameters D of about several hundreds of micrometers (μm).

Further, the effective component generation passage 54 is branched apart into a first flow passage R1 and a second flow passage R2 from the portion in which the effective component generator 56 is arranged. Some of the air current from the upstream side flows through the first flow passage R1 into the bores 60 and 62 and then out of the bores 60 and 62 toward the downstream side. The remaining air current from the upstream side (i.e., in the entire air current sent into the effective component generator 56, the portion of the air current excluding the portion entering the first flow passage) flows through the second flow passage R2, detours the peripheral surfaces of the two electrode unit 58, and then flows out of the second flow passage R2 toward the downstream side.

A regulation valve 63, which regulates the ratio of the air current flowing into the first flow passage R1 and the second flow passage R2, is arranged at the branching portion of the first flow passage R1 and the second flow passage R2. The regulation valve 63 is controlled to keep the flow rate of the air current flowing into the first flow passage R1 constant.

A partition 64 partitions the first flow passage R1 and the second flow passage R2. The partition 64 includes a pipe shaped partition wall 64a and a pip-shaped partition wall 64b. The partition wall 64a partitions the upstream part of the first flow passage R1 (i.e., the part in which air current from the branching portion is drawn into the bores 60 and 62) from the upstream part of the second flow passage R2. The partition wall 64b partitions the downstream part of the first flow passage R1 (i.e., the part in which air current flowing out of the bores 60 and 62 is drawn to a joining part) from the downstream part of the second flow passage R2. The two partition walls 64a and 64b each have one end arranged in contact with the flat surface of the corresponding electrode unit 58.

In the modification of FIG. 9, when the high voltage application unit 61 applies high voltage between the two electrode units 58, microplasmic discharging starts in the discharge area S, which is formed by the bore 60 of the insulative spacer. This generates effective components with high density.

The air current entering the upstream part of the first flow passage R1 and flowing into the bore 60 of the effective component generator 56 carries the effective components, which are generated with high density in the discharge area S, and releases the effective components from the downstream side. The air current entering the upstream part of the second flow passage R2 flows along the flat surface and peripheral surface of the upstream electrode unit 58, the peripheral surface of the insulative spacer 57, and the peripheral surface and flat surface of the downstream electrode unit 58 so as to form a U-shaped flow when viewed from beside. This air current absorbs heat from the two electrode units 58 and releases the heat at the downstream side.

The open amount of the regulation valve 63 is controlled so that the flow rate of the air current entering the first flow passage R1 is kept substantially constant. As a result, microplasmic discharging is stably performed in the bore 60 without being affected by the flow rate of the entire air current. In FIG. 9, two electrode units 58 are used. However, just one of the two electrode units 58, for example, the upstream electrode 58, may be used. Further, the two flow passages R1 and R2 may be applied to the structures of the modifications shown in FIGS. 8A to 8D.

The modification shown in FIG. 10A differs from the modification shown in FIG. 9 in that a gap 59, which has a generally uniform width of several hundreds of micrometers (μm), is formed between the insulative spacer 57 and the upstream and downstream electrode units 58. Further, the modification of FIG. 10A differs from the modification of FIG. 9 in that the diameter of the bore 62 in the downstream electrode unit 58 is greater than the diameter of the bore 60 in the insulative spacer 57 and the bore 62 in the upstream electrode unit 58. The modification of FIG. 10A also differs from the modification of FIG. 9 in that the partition 64 and the regulation valve 63 are eliminated.

The air current entering the effective component generation passage 54 first strikes the upstream electrode unit 58. The air current is then divided into a flow that enters the bore 62 of the upstream electrode unit 58 and reaches the bore 60 of the insulative spacer 57 and a flow that detours the peripheral surface of the upstream electrode 58. The flow that passes through the bore 60 of the insulative spacer 57 is sent further downstream through the large-diameter bore 62 extending through the downstream electrode unit 58. The flow that detours the peripheral surface of the upstream electrode unit 58 is sent further downstream along the peripheral surface of the insulative spacer 57 and the peripheral surface of the downstream electrode unit 58 and then joins the flow that has passed through the bore 62 of the downstream electrode unit 58.

The flow along the peripheral surface of the upstream electrode 58 is partially sent to the bore 60 of the insulative spacer 57 through the gap 59 between the upstream electrode 58 and the insulative spacer 57. Further, the flow from the peripheral surface of the upstream electrode unit 58 to the peripheral surface of the insulative spacer 57 is partially sent to the bore 62 of the downstream electrode unit 58 through the gap 59 between the insulative spacer 57 and the downstream electrode unit 58.

In the modification shown in FIG. 10A, when high voltage is applied between the two electrode units 58, microplasmic discharging starts in the bore 60 of the insulative spacer 57, the gap 59 between the insulative spacer 57 and the upstream electrode unit 58, and the gap 59 between the insulative spacer 57 and the downstream electrode unit 58. In other words, the bore 60 of the insulative spacer 57 and the upstream and downstream gaps 59 form a fine discharge area S along the insulative spacer 57. As described above, the bore 62 of the downstream electrode unit 58 has a large diameter. This suppresses collection of the effective components, which are generated at the discharge area S, in the downstream electrode unit 58.

The modification shown in FIG. 10B differs from the modification shown in FIG. 10A in that the insulative spacer 57 and the upstream electrode unit 58 are in contact with each other. In the modification of FIG. 10B, a fine discharge area S is also formed along the insulative spacer 57 by the bore 60 of the insulative spacer 57 and the gap 59 between the insulative spacer 57 and the downstream electrode unit 58.

The gap 59 of the discharge area S may be arranged between the insulative spacer 57 and the upstream electrode unit 58, and the downstream electrode unit 58 may be arranged in contact with the insulative spacer 57. In this case as well, the large amount of effective components generated in the discharge area S is carried downstream, and heat is efficiently absorbed from the effective component generator 56.

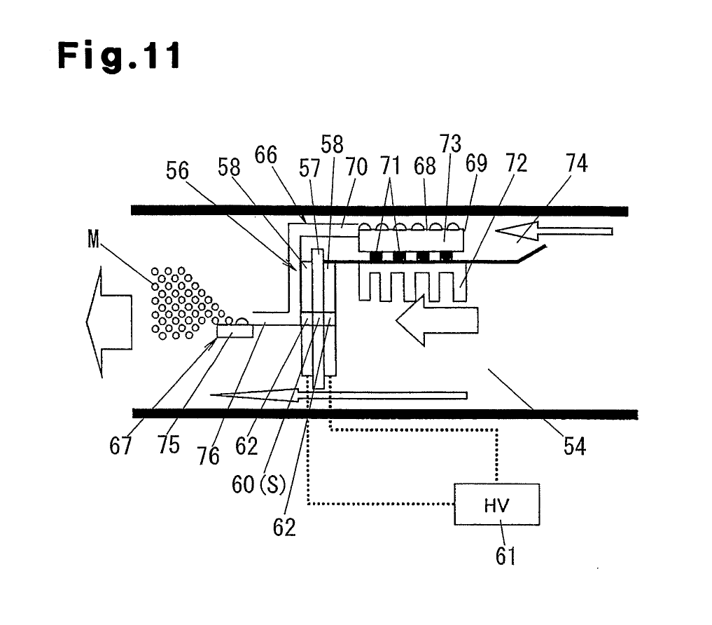

In addition to the structure of the modification shown in FIG. 9, the modification shown in FIG. 11 includes a liquid reservoir 76, a liquid supplying means 66, and an atomization unit 67. The liquid reservoir 76 is arranged in communication with a downstream end of the downstream electrode unit 58. The liquid supplying means 66 supplies liquid to the liquid reservoir 76. The atomization unit 67 atomizes the liquid in the liquid reservoir. In the same manner as the modifications shown in FIGS. 10A and 10B, this modification does not include the partition 64 and the regulation valve 63.

For example, the liquid supplying means 66 includes a cooling device 69, which has a cooling surface 68 for producing condensed water, and a liquid supplying pipe 70, which is arranged between the cooling surface 68 and the liquid reservoir 76. The cooling device 69 includes a plurality of Peltier elements 71, heat radiation fins 72, which are connected to the heat radiating side of the Peltier elements 71, and a cooling plate 73, which is connected to the cooling side of the Peltier elements 71.

The effective component generation passage 54 includes a cooling passage 74, which is branched from a main current passage extending through the discharge area S (bore 60) and joined with the main current passage at the downstream side after detouring the effective component generator 56. The cooling plate 73 of the cooling device 69 is exposed in the cooling passage 74. The heat radiation fins 72 of the cooling device 69 are exposed at a location that is downstream to a branching point of the cooling passage 74 from the main current passage in the effective component generation passage 54 and upstream to the effective component generator 56.

The cooling surface 68, which is formed on a surface of the cooling plate 73, supplies condensed water, which is produced on the cooling surface 68 from the moisture in the air, through the liquid supplying pipe 70 to the pipe-shaped liquid reservoir 76. In the illustrated example, the liquid supplying pipe 70 and the liquid reservoir 76 include a series of pipes that form a crank shape. Instead of the liquid supplying pipe 70, a fibrous member, such as felt, or a porous member, which is formed from a foamed material or a ceramic, may be used to supply liquid. Further, the structure of the liquid supplying means 66 may be changed so as to recover moisture from the air and release the moisture using a hygroscopic agent, such a silica gel or zeolite.

The atomization unit 67 includes, for example, an ultrasonic vibrator 75, atomizes the liquid supplied from the liquid reservoir 76 through ultrasonic vibration, and sends out the atomized liquid. The atomization unit 67 is not limited to the structure described above. For example, the atomization unit 67 may have a structure that atomizes liquid with a surface acoustic wave, a structure that blasts pressurized liquid against a wall surface, or a structure that sprays liquid using a pump. Further, a vaporization unit may be used in lieu of the atomization unit 67 to vaporize the liquid in the liquid reservoir 76 with heat or an air current and send out the vaporized liquid.

In the modification of FIG. 11, the effective components generated in the discharge area S (bore 60) of the effective component generator 56 is sent directly into the liquid reservoir 76, dissolved in the liquid in the liquid reservoir 76, and then atomized by the atomization unit 67. In other words, mist M, in which the effective components are dissolved in a concentrated state, is released from of the effective component generator 56.

When superoxide radicals or hydroxyl radicals, which are significantly generated as the effective components, are dissolved in water, hydrogen peroxide water is generated. Accordingly, the mist M released from the effective component generator 56 includes hydrogen peroxide water and has deodorizing and sterilization effects. The effective components generated in the discharge area S are dissolved in liquid (condensed water) to reform the condensed water and add deodorizing and sterilization effects.

Further, the arrangement of the liquid reservoir 76, which is in contact with the downstream side of the effective component generator 56, obtains an effect that cools the electrode units 58 and the insulative spacer 57, which are heated during discharging. The bores 60 and 62 have very fine diameters. This prevents the liquid in the liquid reservoir 76 from entering the bores 60 and 62.

The liquid reservoir 76, which is located in the downstream vicinity of the discharge area S, obtains an effect that drastically enhances the generation reaction of effective components. This is because the air sent from the discharge area S generates fine bubbles in the liquid reservoir 76, and discharging occurs in the bubbles near the discharge area S. The discharged portion in the fine bubbles is supplied with moisture from the surrounding liquid. This enhances the generation reaction of the effective components. The enhanced generation reaction is the same as the generation reaction of the second embodiment.

In the example of FIG. 11, the electrode units 58 are arranged on opposite sides of the insulative spacer 57. However, an electrode unit 58 may be arranged on just one side (e.g., upstream side) of the insulative spacer 57. In this case as well, the liquid reservoir 76 is arranged in communication with the bore 60 of the insulative spacer 57. Thus, the effective components are directly sent into and dissolved in the liquid reservoir 76.

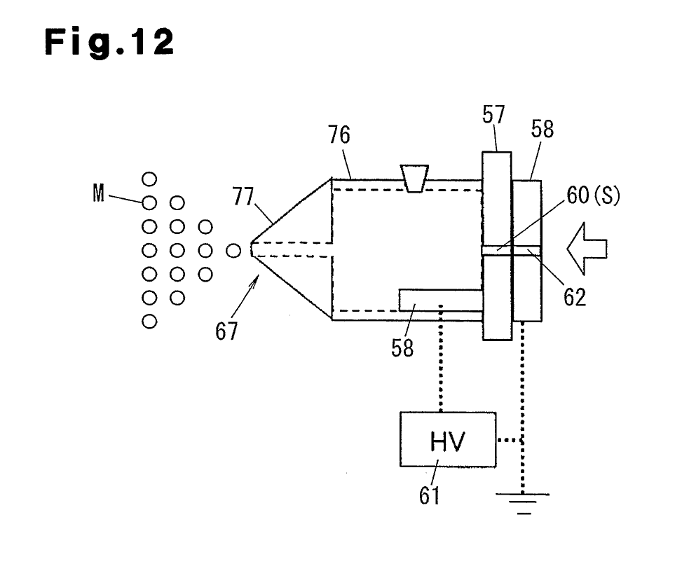

FIG. 12 shows a modification that differs from the modification of FIG. 11 in that an electrostatic atomization phenomenon is used as a means for atomizing the liquid in the liquid reservoir 76.

In this modification, the electrode unit 58 is arranged in contact with the upstream side of the insulative spacer 57. Further, a tank type liquid reservoir 76 is arranged in contact with the downstream side of the insulative spacer 57. In other words, the downstream end of the bore 60 in the insulative spacer 57 is in communication with the liquid reservoir 76. The downstream electrode unit 58, which is paired with the upstream electrode unit 58, is arranged in the liquid reservoir 76. When voltage is applied between the two electrode units 58 through the liquid contained in the liquid reservoir 76, microplasmic discharging occurs in the bore 60 of the insulative spacer 57.

Further, in the modification of FIG. 12, the downstream electrode unit 58 in the liquid reservoir 76 also functions as an electrostatic atomization electrode. A liquid conveying unit 77 projects from the liquid reservoir 76 to supply the liquid in the liquid reservoir for electrostatic atomization. The electrode unit 58 in the liquid reservoir 76 applies high electrostatic atomization voltage to the liquid conveyed to the distal end of the liquid conveying unit 77 by the capillary phenomenon.

The application of high voltage to the liquid conveyed to the distal end of the liquid conveying unit 77 forms Taylor cones, and the electrostatic atomization phenomenon generates a large amount of mist M. In this manner, the atomization unit 67 employs an atomization structure for performing electrostatic atomization on the liquid in the liquid reservoir 76 to atomize the liquid. This structure is advantageous in that the liquid in which effective components are dissolved are released as the mist M, which is charged and includes particles of an extremely fine diameter such as nanometer size particles. Instead of using the downstream electrode unit 58 as the electrostatic atomization electrode, an exclusive electrode may be used for the purpose of electrostatic atomization.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

1. A refrigerator comprising:
a refrigerator body including a storing compartment; and
an effective component generation device that is arranged in the refrigerator body and releases effective components in the storing compartment, the effective component generation device including:
an effective component generator that generates the effective components when discharging occurs; and
an effective component generation passage in which the effective component generator is arranged;
wherein the effective component generator includes an electrode unit and an insulative spacer arranged in contact with or near the electrode unit, with high voltage being applied to the electrode unit so that the discharging occurs in a fine discharge area formed along the insulative spacer; and
the effective component generation passage is formed so that air current sent into the effective component generator flows by the discharge area and a peripheral surface of the electrode unit.

2. The refrigerator according to claim 1, wherein the discharge area is at least either one of a bore extending through the insulative spacer and a gap formed between the insulative spacer and the electrode unit.

3. The refrigerator according to claim 1, wherein the refrigerator body further includes a supplying device that supplies water to at least either one of an upstream side and downstream side of the insulative spacer in the effective component generation passage.

4. The refrigerator according to claim 3, wherein the supplying device is formed to supply the effective component generation device with condensed water produced in the storing compartment.

5. The refrigerator according to claim 4, wherein the refrigerator body further includes a plurality of storing compartments, and the supplying device is formed to produce the condensed water using a difference in temperature between adjacent ones of the storing compartments.

6. The refrigerator according to claim 5, wherein the supplying device uses the temperature of a cooler one of the storing compartments to cool a cooling member arranged in a warmer one of the storing compartments and produce the condensed water.

7. The refrigerator according to claim 4, wherein the refrigerator body further includes a current passage that sends cool air into the storing compartment, and the supplying device is formed to produce the condensed water using a difference between temperature of the storing compartment and temperature of the current passage.

8. The refrigerator according to claim 7, wherein the supplying device uses the temperature of the current passage, which is cooler than the storing compartment, to cool a cooling member arranged in the storing compartment and produce the condensed water.

9. The refrigerator according to claim 3, wherein the refrigerator body further includes a water supplying unit that supplies water to an icemaker, and the water supplying unit is formed to supply some of the water in the water supplying unit to the effective component generation device.

10. The refrigerator according to claim 1, wherein the discharge area includes at least one bore extending through the insulative spacer, and the electrode unit includes at least one bore in alignment with or out of alignment with the bore of the insulative spacer.

11. The refrigerator according to claim 10, wherein the effective component generation passage includes a first flow passage, which is in communication with the bore of the electrode unit and the bore of the insulative spacer, and a second flow passage, which is separate from the first flow passage and extends along the peripheral surface of the electrode unit and a peripheral surface of the insulative spacer.

12. The refrigerator according to claim 10, wherein the electrode unit is arranged in the effective component generation passage upstream to the insulative spacer, and the effective component generator includes a further electrode unit arranged downstream to the insulative spacer, the further electrode unit including a bore having a diameter larger than that of the bore of the insulative spacer.

13. The refrigerator according to claim 1, wherein the effective component generation device further includes a liquid reservoir, which is in communication with a downstream side of the discharge area, and a device that atomizes or vaporizes liquid contained in the liquid reservoir.

14. An effective component generation device that releases effective components in a storing compartment of a refrigerator body, the effective component generation device comprising:
an effective component generator that generates the effective components when discharging occurs; and
an effective component generation passage in which the effective component generator is arranged;
wherein the effective component generator includes an electrode unit and an insulative spacer arranged in contact with or near the electrode unit, with high voltage being applied to the electrode unit so that the discharging occurs in a fine discharge area formed along the insulative spacer; and
the effective component generation passage is formed so that air current sent into the effective component generator flows by the discharge area and a peripheral surface of the electrode unit.

15. The effective component generation device according to claim 14, wherein the discharge area includes a bore, which extends through the insulative spacer, and a gap, which is formed between the insulative spacer and the electrode unit; and
the effective component generation passage includes a first flow passage, which sends some of the air current drawn into the effective component generator to the discharge area from the peripheral surface of the electrode unit, and a second flow passage, which sends the remaining air current drawn into the effective component generator to a peripheral surface of the insulative spacer from the peripheral surface of the electrode unit, with the second flow passage being in communication with the first flow passage through the discharge area.
